(19) United States
(12) Patent Application Publication
(10) Pub. No.: US 2026/0238392 A1
(43) Pub. Date: Aug. 13, 2026

(54) RETRANSMISSION SCHEME BASED ON A TRIGGERING CONDITION

(71) Applicant: InterDigital Patent Holdings, Inc., Wilmington, DE (US)

(72) Inventors: Tuong Duc Hoang, Montreal (CA); Martino M. Freda, Laval (CA); Oumer Teyeb, Montreal (CA); Ananth Kini, Conshohocken, PA (US)

(73) Assignee: InterDigital Patent Holdings, Inc., Wilmington, DE (US)

(21) Appl. No.: 19/156,108

(22) PCT Filed: Feb. 13, 2024
(86) PCT No.: PCT/US2024/015489

§ 371 Date: Aug. 13, 2025

Related U.S. Application Data
(60) Provisional application No. 63/445,499, filed on Feb. 14, 2023.

(51) Int. Cl. H04L 1/1825; H04L 1/1867

(52) U.S. Cl. CPC H04L 1/1825; H04L 1/1896

(57) ABSTRACT

A wireless transmit/receive unit (WTRU) may transmit data associated with a protocol data unit (PDU). The WTRU may receive a retransmission request for the data associated with the PDU. The WTRU may determine a retransmission scheme based on a triggering condition. The WTRU may send the data associated with the PDU using the determined retransmission scheme. For example, the WTRU may determine that a first triggering condition of multiple triggering conditions is satisfied. The first triggering condition may that the WTRU has retransmitted at least a threshold number of times. The WTRU may determine, based at least on the satisfaction of the first triggering condition, a retransmission scheme to send the data. The retransmission scheme may include a retransmission of the data associated with the PDU using a sidelink (SL) and an uplink (UL).

### CROSS-REFERENCE TO RELATED APPLICATIONS

This application claims the benefit of U.S. Provisional Application No. 63/445,499, filed Feb. 14, 2023, the content of which is incorporated by reference herein.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems, methods, and instrumentalities are described herein related to a determination of a retransmission scheme. In examples, a wireless transmit/receive unit (WTRU) may transmit data associated with a protocol data unit (PDU). The WTRU may receive a retransmission request for the data associated with the PDU. The WTRU may determine a retransmission scheme based on a triggering condition. The WTRU may send the data associated with the PDU using the determined retransmission scheme. For example, the WTRU may determine that a first triggering condition of multiple triggering conditions is satisfied. The first triggering condition may that the WTRU has retransmitted at least a threshold number of times. The WTRU may determine, based at least on the satisfaction of the first triggering condition, a retransmission scheme to send the data. The retransmission scheme may include a retransmission of the data associated with the PDU using a sidelink (SL) and an uplink (UL). The WTRU may send the data associated with the PDU using the determined retransmission scheme. In examples, the retransmission of the data using the SL and the UL may include sending the data on the SL and sending the data on the UL.

In examples, the first triggering condition may be one of multiple triggering conditions for the WTRU to determine the retransmission scheme. For example, the retransmission scheme may be determined based on the satisfaction of a second triggering condition of the multiple triggering conditions. The PDU may be a radio link control (RLC) PDU. The second triggering condition may be that a remaining RLC delay associated with the RLC PDU is equal to or greater than a threshold RLC delay. In examples, the WTRU may receive configuration information that indicates the threshold RLC delay and/or the threshold number of times. In some examples, the WTRU may receive a missing sequence number (SN) report that indicates the retransmission request for the data associated with the PDU.

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example of a user plane protocol stack for an L2 WTRU-to-Network relay.

FIG. 3 illustrates an example of a control plane protocol stack for an L2 WTRU-to-Network relay.

FIG. 4 illustrates an example of a DC architecture for a split bearer.

FIG. 5 illustrates an example of a protocol stack for carrier aggregation.

FIG. 6 illustrates an example 600 of a protocol stack for multipath.

### DETAILED DESCRIPTION

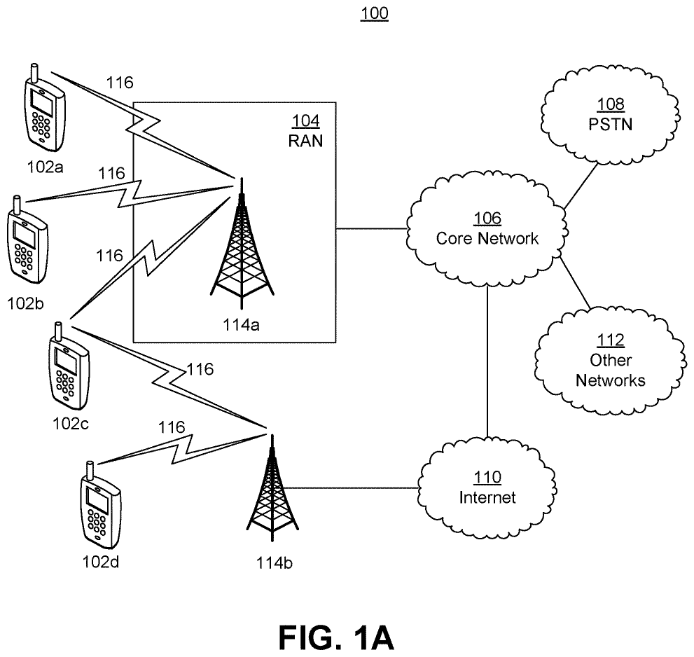

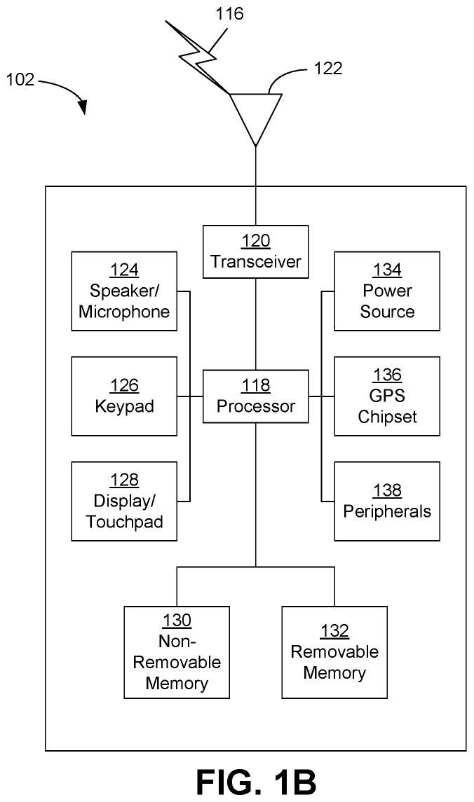

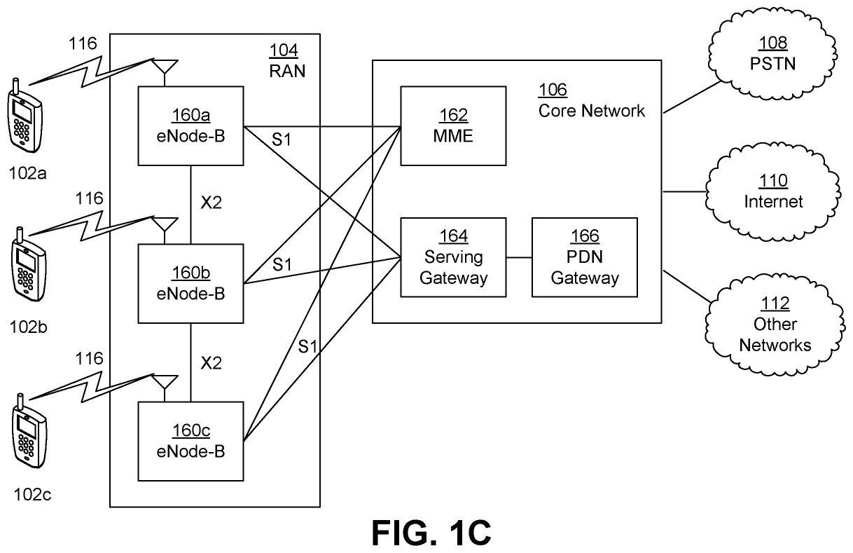

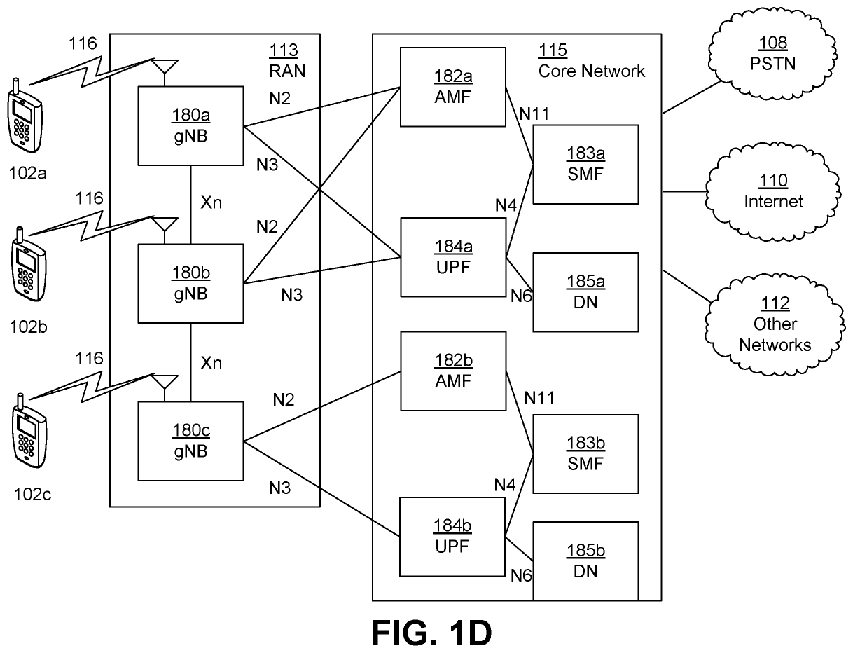

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 182 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems, methods, and instrumentalities are described herein related to radio link control (RLC) protocol data unit (PDU) retransmission. A device (e.g., a wireless transmit/receive unit (WTRU), such as a remote WTRU) may determine whether to retransmit an RLC acknowledged mode (AM) protocol data unit (PDU) in two legs or one leg based on the number of RLC retransmissions made and the remaining RLC delay of the RLC PDU. A device may (e.g., be configured to) perform one or more of the following actions. For example, a WTRU (e.g., a remote WTRU) may be (pre)configured with at least one of the following parameters to trigger RLC AM PDU retransmission in two legs (e.g., a Uu leg and a sidelink (SL) leg): a threshold for the number of RLC PDU retransmissions and/or a threshold for the remaining RLC delay. The device may transmit an RLC PDU. The device may receive a retransmission request for a (e.g., one) RLC PDU (e.g., based on the missing sequence number (SN) reporting from the relay). The device may retransmit the RLC PDU on two legs, for example, if the number of retransmissions of the RLC PDU is greater than the configured threshold or the remaining RLC delay of the RLC PDU is greater than the configured threshold. The device may retransmits the RLC in the same leg, for example, if otherwise (e.g., if the number of retransmissions of the RLC PDU is not greater than the configured threshold and the remaining RLC delay of the RLC PDU is greater than the configured threshold).

An example device may include a processor configured to perform one or more actions. For example, a device (e.g., WTRU) may (e.g., be configured to) receive a retransmission request associated with a data unit. The device may determine whether to retransmit the data unit in a plurality of legs. The device may retransmit the data unit based on the determination. The retransmission request may be associated with a radio link control (RLC) protocol data unit (PDU).

The device may (e.g., be configured to) compare a number of retransmissions of the data unit to a data unit retransmission threshold. The data unit may be determined to be retransmitted in the plurality of legs, for example, based on the number of retransmissions of the data unit exceeding the data unit retransmission threshold.

The device may (e.g., be configured to) compare a remaining RLC delay associated with the RLC PDU to a remaining RLC delay threshold. The data unit may be determined to be retransmitted in the plurality of legs, for example, based on the remaining RLC delay associated with the RLC PDU exceeding the remaining RLC delay threshold.

The device may (e.g., be configured to) compare a number of retransmissions of the data unit to a data unit retransmission threshold. The device may (e.g., be configured to) compare a remaining RLC delay associated with the RLC PDU to a remaining RLC delay threshold. The data unit may be determined to be retransmitted in a same leg based on the number of retransmissions of the data unit being less than the data unit retransmission threshold, and the remaining RLC delay associated with the RLC PDU being less than the remaining RLC delay threshold. The legs may comprises a Uu leg and a sidelink leg.

Systems, methods, and instrumentalities are described herein related to a determination of a retransmission scheme. In examples, a wireless transmit/receive unit (WTRU) may transmit data associated with a protocol data unit (PDU). The WTRU may receive a retransmission request for the data associated with the PDU. The WTRU may determine a retransmission scheme based on a triggering condition. The WTRU may send the data associated with the PDU using the determined retransmission scheme. For example, the WTRU may determine that a first triggering condition of multiple triggering conditions is satisfied. The first triggering condition may that the WTRU has retransmitted at least a threshold number of times. The WTRU may determine, based at least on the satisfaction of the first triggering condition, a retransmission scheme to send the data. The retransmission scheme may include a retransmission of the data associated with the PDU using a sidelink (SL) and an uplink (UL). The WTRU may send the data associated with the PDU using the determined retransmission scheme. In examples, the retransmission of the data using the SL and the UL may include sending the data on the SL and sending the data on the UL

In examples, the first triggering condition may be one of multiple triggering conditions for the WTRU to determine the retransmission scheme. For example, the retransmission scheme may be determined based on the satisfaction of a second triggering condition of the multiple triggering conditions. The PDU may be a radio link control (RLC) PDU. The second triggering condition may be that a remaining RLC delay associated with the RLC PDU is equal to or greater than a threshold RLC delay. In examples, the WTRU may receive configuration information that indicates the threshold RLC delay and/or the threshold number of times. In some examples, the WTRU may receive a missing sequence number (SN) report that indicates the retransmission request for the data associated with the PDU.

An example architecture of a wireless transmit/receive unit (WTRU) to network (NW) relay is described herein. An example of the protocol stacks for the user plane and control plane of a layer two (L2) user-to-network (U2N) relay architecture are illustrated in figures. The SL relay adaptation protocol (SRAP) sublayer may be placed, for example, above the radio link control (RLC) sublayer for both cyclic prefix (CP) and UP at both PC5 interface and Uu interface. The Uu service data adaptation protocol (SDAP), packet data convergence protocol (PDCP), and radio resource control (RRC) may be terminated between L2 U2N remote WTRU and gNB, while SRAP, RLC, medium access control (MAC) and physical (PHY) may be terminated in each hop (e.g., the link between L2 U2N remote WTRU and the L2 U2N relay WTRU and the link between L2 U2N relay WTRU and the gNB).

For L2 U2N Relay, the SRAP sublayer over PC5 hop may be (e.g., only) for the purpose of bearer mapping. The SRAP sublayer may not be present over PC5 hop for relaying the L2 U2N Remote WTRU's message on broadcast control channel (BCCH) and paging control channel (PCCH). For L2 U2N Remote WTRU's message on signaling RB zero (SRB0), the SRAP header may not be present over a PC5 hop, but the SRAP header may be present over a Uu hop for both downlink (DL) and uplink (UL).

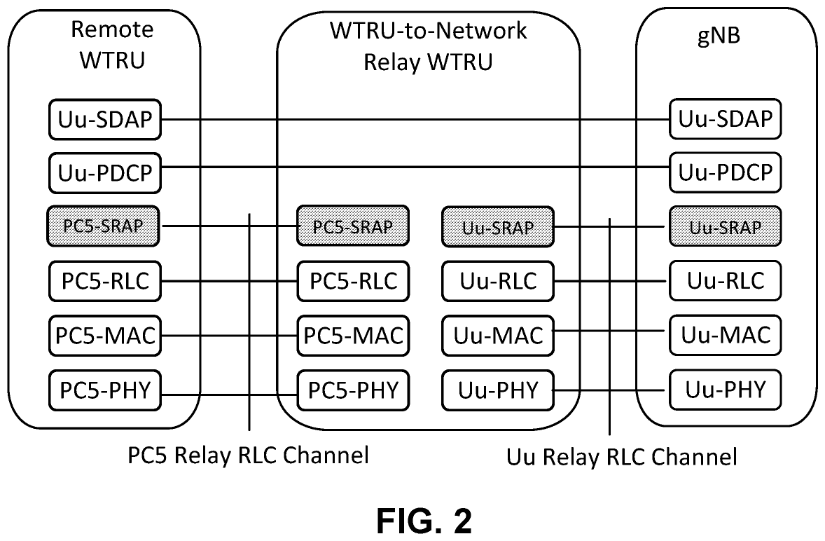

FIG. 2 illustrates an example of a user plane protocol stack for an L2 WTRU-to-Network relay.

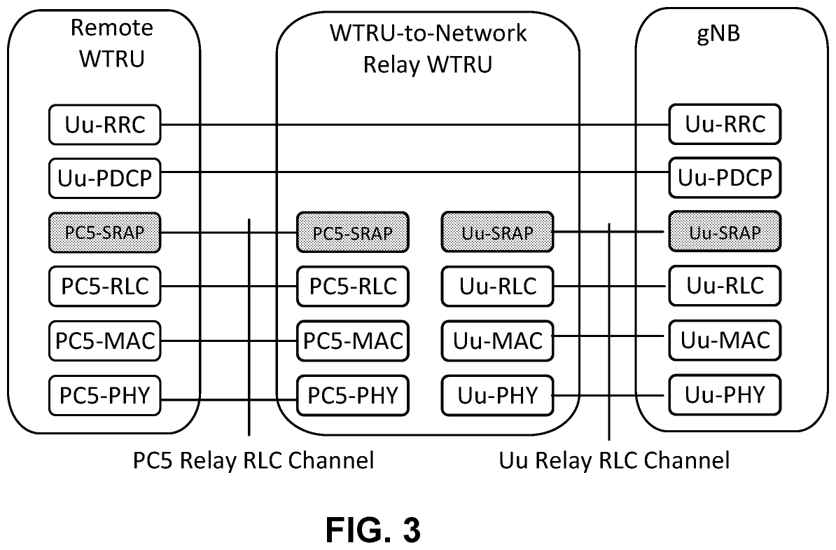

FIG. 3 illustrates an example of a control plane protocol stack for an L2 WTRU-to-Network relay.

Mode 1 and Mode 2 resource allocation may be provided. An SL WTRU may be configured to operate in either mode 1 or mode 2. In mode 1, the WTRU may be scheduled on SL by the network (e.g., downlink control information (DCI) scheduling SL grants). In mode 2, the WTRU may perform resource (re)selection to schedule SL resources.

Mode 2 resource selection may be (e.g., further) characterized by the potential use of sensing. A WTRU that supports sensing may use the results of sensing (e.g., the indication of SL control information (SCI) transmissions over a period of time that are forward booking resources) to select a set of resources for transmission. Resource selection may include determining a set of available resources based on the sensing results and comparing the observed SCI's reference signal received power (RSRP) with a threshold, which may be dependent on the priority of the transmission to be made during the sensing and the transmission announced by the other SCI. If a certain percentage of resources is deemed available, a WTRU may randomly select resources (e.g., either for a single transmission, or for multiple periodic transmissions announced by a forward booking indication in SCI) to be used for transmission. When insufficient resources are available to perform random selection, the WTRU may increase its threshold for availability (e.g., by 3 dB) until a sufficient number of resources is deemed available.

Mode 2 resource selection may be (e.g., further) limited by congestion control. The WTRU may measure the channel busy ratio (CBR). The WTRU may be configured with one or more limitations in transmission based on the CBR (e.g., max number of retransmission, modulation and coding scheme (MCS), maximum number of subchannels, etc.) to avoid congestion, which may be further increased when the CBR is high. Congestion parameters may be (e.g., further) conditioned on the priority of a transmission, e.g., so that high priority transmissions suffer less from congestion control limitations.

Multipath with relay may involve a remote WTRU connected to a network via direct and indirect paths may improve reliability, robustness, and/or throughput. A multi-path relay may be utilized for WTRU aggregation. A WTRU may be connected to the network via direct path and via another WTRU, e.g., using a non-standardized WTRU-WTRU interconnection. WTRU aggregation may support applications utilizing high UL bitrates on 5G terminals, e.g., in cases when normal WTRUs may be too limited by UL WTRU transmission power to achieve required bitrate, especially at the edge of a cell. WTRU aggregation may improve reliability, stability, and/or reduce delay of services. For example, if the channel condition of a terminal is deteriorating, another terminal may be used to make up for the traffic performance unsteadiness caused by channel condition variation.

Multipath operation may enhance reliability and throughput (e.g., by switching among or utilizing multiple paths simultaneously) in one or more scenarios (e.g., RAN2, RAN3). A WTRU may be connected to the same gNB using one direct path and one indirect path, e.g., via a Layer-2 WTRU-to-Network relay, or via another WTRU, such as a WTRU-WTRU inter-connection.

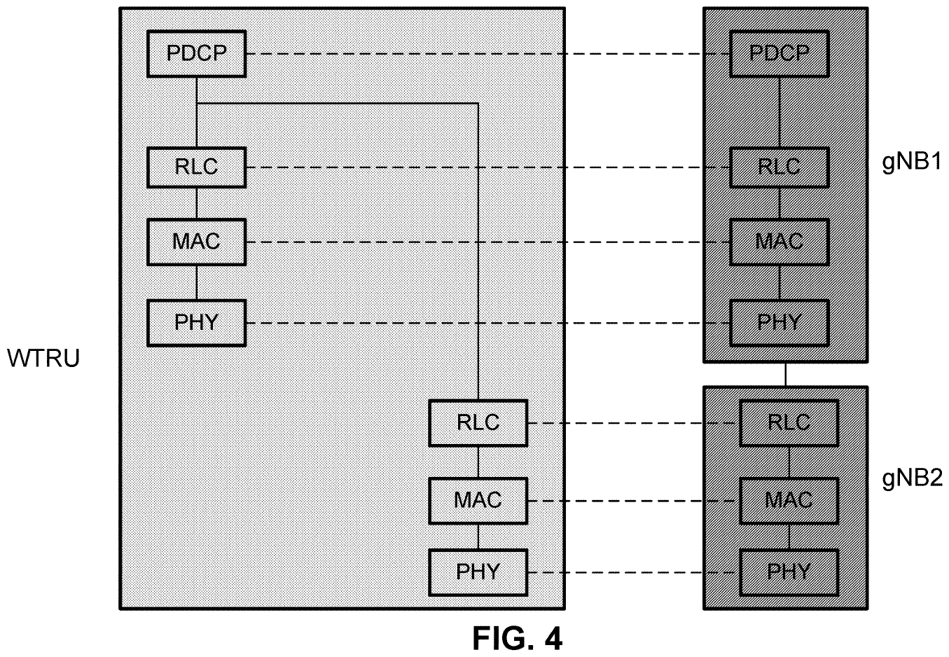

In Dual Connectivity (DC), a WTRU may be served by multiple (e.g., two) nodes (e.g., each comprising a set of cells, referred to as the Master Cell Group (MCG) and Secondary Cell Group (SCG)). A bearer may be associated with (e.g., only) the MCG or SCG, or the bearer may be configured to be a split bearer. FIG. 4 shows the protocol view of a split bearer.

FIG. 4 illustrates an example of a DC architecture for a split bearer.

Like a bearer (e.g., any bearer), the WTRU may have one PDCP entity associated with it, and the peer PDCP entity on the network side may be terminated at one of the gNBs (e.g., at the master or the secondary). In the DL, the CN may send the data to the gNB where the PDCP is terminated (e.g., gNB1 shown in FIG. 4). The network may directly send the data to the WTRU via the link between that gNB and the WTRU, or the PDCP PDUs may be forwarded to gNB2 (e.g., via an Xn interface), and the gNB may send the data to the WTRU via the link between the gNB and the WTRU.

In the UL, the WTRU may be configured with one of the paths as the primary path, and the other as a secondary path. A threshold (e.g., UL split buffer threshold), may be configured. If the UL buffer size for the bearer is less than the threshold, the PDCP may push the data (e.g., only) to the RLC associated with the primary path. If the buffer size becomes larger than the threshold, the WTRU may push the data to either path (e.g., left to WTRU implementation).

In carrier aggregation (CA), data in a bearer may be transmitted in a carrier (e.g., any carrier). A logical channel at the MAC layer may send data in a flexible manner to either carrier (e.g., or may be configured with a duplicate logical channel to allow CA duplication with carrier restriction).

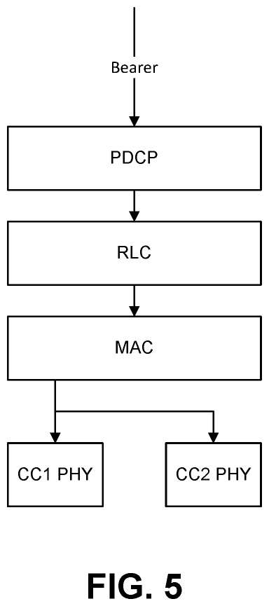

FIG. 5 illustrates an example of a protocol stack for carrier aggregation (CA).

Triggers for Uu and SL buffer status requests (BSRs) (e.g., regular BSRs) may be similar. A BSR may be triggered, for example, if one or more of the following events occur for an activated cell group: UL data (e.g., for a logical channel that belongs to an LCG) becomes available to the MAC entity; UL resources are allocated; a retxBSR-Timer expires; and/or a periodicBSR-Timer expires.

A BSR may be triggered, for example, if UL data, for a logical channel which belongs to an LCG, becomes available to the MAC entity and if the UL data belongs to a logical channel with higher priority than the priority of a (e.g., any) logical channel including available UL data that belongs to a (e.g., any) LCG or if none of the logical channels that belong to an LCG include (e.g., any) available UL data. In either case, the BSR is referred to (e.g., herein) as a “Regular BSR.”

A BSR may be triggered, for example, if UL resources are allocated and the number of padding bits is equal to or larger than the size of the Buffer Status Report MAC CE plus its subheader, in which case the BSR may be referred to (e.g., herein) as a “Padding BSR.”

A BSR may be triggered, for example, if retxBSR-Timer expires, and at least one of the logical channels that belong to an LCG includes UL data, in which case the BSR may be referred to (e.g., herein) as a “Regular BSR.”

A BSR may be triggered, for example, if periodicBSR-Timer expires, in which case the BSR may be referred to (e.g., herein) as a “Periodic BSR.”

A (e.g., each) logical channel may trigger a (e.g., one) separate Regular BSR, for example, if/when Regular BSR triggering events occur for multiple logical channels simultaneously.

Resource reselection may occur. A WTRU may trigger resource (re)selection (e.g., in mode 2), for example, based on the following triggers/procedure. The MAC entity may (e.g., for the SL process) clear the selected SL grant associated with the SL process, if available, and trigger the TX resource (re)selection, for example, if the TX resource (re)selection check procedure is triggered on the selected pool of resources for an SL process and at least one of the following conditions is met: (i) PSCCH duration(s) and second (2nd) stage SCI on PSSCH for (e.g., all) transmissions of a MAC PDU of a (e.g., any) selected SL grant(s) are not in SL DRX Active time of the destination that has data to be sent; (ii) SL_RESOURCE_RESELECTION_COUNTER=0 and when SL_RESOURCE_RESELECTION_COUNTER was equal to 1 the MAC entity randomly selected, with equal probability, a value in the interval [0, 1] which is above the probability configured by RRC in sl-ProbResourceKeep; (iii) the pool of resources is configured or reconfigured by RRC; (iv) there is no selected SL grant on the selected pool of resources; (v) neither transmission nor retransmission has been performed by the MAC entity on a (e.g., any) resource indicated in the selected SL grant during the last second; (vi) sl-ReselectAfter is configured and the number of consecutive unused transmission opportunities on resources indicated in the selected SL grant, which is incremented by 1 when none of the resources of the selected SL grant within a resource reservation interval is used, is equal to sl-ReselectAfter; (vii) the selected SL grant cannot accommodate a RLC SDU by using the maximum allowed MCS configured by RRC in sl-MaxMCS-PSSCH associated with the selected MCS table and the WTRU selects not to segment the RLC SDU (e.g., If the selected SL grant cannot accommodate the RLC SDU, it may be left for WTRU implementation whether to perform segmentation or SL resource reselection); (viii) transmission(s) with the selected SL grant cannot fulfil the remaining PDB of the data in a logical channel, and the MAC entity selects not to perform transmission(s) corresponding to a single MAC PDU. If the remaining PDB is not met, it may be left for WTRU implementation whether to perform transmission(s) corresponding to single MAC PDU or SL resource reselection. It may be left for WTRU implementation whether to trigger the TX resource (re)selection due to a latency requirement of a MAC CE triggered in one or more cases.

In examples, a WTRU may, for example, based on the arrival of one or more flexible RBs, determine the resource allocation behavior(s) associated with the flexible RBs, which may include determining whether to perform resource allocation(s), determining when to perform resource allocation(s), and/or determining the associated parameters for resource allocation(s). A WTRU (e.g., with a grant in SL and/or Uu for the flexible RBs) may determine whether to push a flexible RB in the grant and/or determine which flexible bearer(s) to multiplex in a transport block (TB) for transmission in the grant.

In some examples (e.g., in DC), PDCP (e.g., a PDCP entity) may decide whether to push data in MCG or SCG based on buffer status(es) (e.g., purely based on buffer status(es)). A WTRU may determine (e.g., according to a WTRU implementation) how much data to push to which RLC channel. In some examples, a flexible approach may be used in multipath of a remote WTRU, where data may be flexibly routed (e.g., as shown in one or examples related to carrier aggregation) to either path depending on availability of grants. A carrier aggregation model may not be directly used for multipath (e.g., use of a carrier aggregation model directly to multipath in some instances may cause issues). In some examples, a logical channel on Uu and a logical channel on SL may have different configurations in RRC (e.g., drastically different configurations in RRC) such that it may be difficult to define a logical channel when data available for a logical channel can be flexibly transmitted to an SL path (e.g., indirect such as a relayed path) or a Uu (e.g., direct) path.

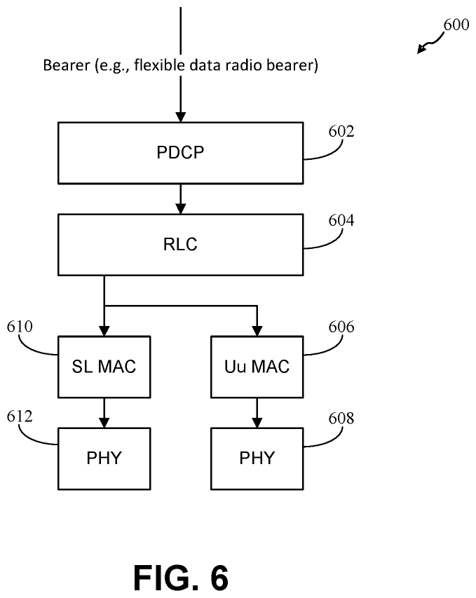

In one or more examples as described herein, a protocol stack for multipath (e.g., the example shown in FIG. 6) may be used for flexible scheduling (e.g., more flexible CA-based scheduling than one or more examples where an DC approach and/or a direct CA approach are used).

FIG. 6 illustrates an example of a protocol stack for multipath. Multipath may be used to support a data bearer, for example, a flexible RB. In examples, a flexible RB may be capable of being used to transmit the data via an SL, a UL, or a combination of the SL and the UL.

The example 600 in FIG. 6 may include PDCP 602, RLC 604, SL MAC 610, PHY 612, Uu MAC 606, and PHY 608. As shown in the example 600 (e.g., an example architecture) in FIG. 6, an RLC entity 604 (e.g., a single RLC entity that can flexibly send data via an SL path and/or a Uu path) may be configured with separate logical channels. An SL logical channel may be used for data transmissions via an indirect path (e.g., via an SLC MAC 610 and PHY 612), and/or a Uu logical channel may be used for data transmissions via a direct path (e.g., via Uu MAC 606 and PHY 608). The Uu logical channel may be configured for the direct path (e.g., the Uu logical channel may behave like a legacy Uu logical channel). An SL logical channel may be configured with the indirect path (e.g., the SL logical channel may behave like SL logical channels in one or more examples herein). Duplication may be supported (e.g., using the example 600 in FIG. 6). For example, the RLC entity 604 may transmit a PDU via both paths (e.g., the indirect path and the direct path). Both logical channels (e.g., the SL logical channel and the Uu logical channel) may transmit the data on their respective interface (e.g., SL and Uu).

One or more examples described herein may be applied to flexible RBs (e.g., which may be capable of being used to dynamically send data over SL path and/or Uu path without the need of RRC reconfiguration). However, without loss of generality, the examples may be (e.g., additionally and/or alternatively) applied to the Uu RBs and/or the SL RBs.

A WTRU may determine one or more parameters for multipath operation(s).

A WTRU may be configured with RBs. A WTRU may be configured with one or more of the following data RBs: Uu RBs (e.g., for stringent latency); sidelink RBs (e.g., for long latency data); and/or flexible RBs (e.g., for medium latency data and high reliability).

A WTRU may be configured with Uu RBs (e.g., for stringent latency). For example, a Uu RB may be configured to transmit data via Uu. A WTRU may be configured with SL RBs (e.g., for long latency data). For example, an SL RB may be configured to transmit data via an SL. A WTRU may be configured with flexible RBs (e.g., for medium latency data and high reliability). For example, a flexible RB may be configured to transmit data via Uu and/or SL.

A WTRU may be (e.g., further) configured with additional parameters for a flexible RB. For example, a WTRU may be configured with a primary path and/or a secondary path for a flexible RB.

A WTRU may determine one or any combination of the following parameters for a buffer status (e.g., the WTRU's buffer status): a QoS of data in the buffer; a type of data in the buffer; an amount of a type of data (e.g., an amount of each type of data) in the buffer; the total data in the buffer; and/or the amount of data in a configured set of RBs. A WTRU may determine the QoS (e.g., one or more of the priority, reliability, latency, and/or remaining delay budget) of the data in a buffer. A WTRU may determine the type of data in a buffer. For example, a WTRU may determine whether there is (e.g., in the buffer) one or more of: a Uu RB, an SL RB, a flexible RB, a flexible RB with a primary path as Uu, and/or a flexible RB with a primary path as SL. A WTRU may determine the amount of a type (e.g., each type) of data in a buffer. For example, a WTRU may determine the amount of one or more (e.g., each) types of RB (e.g., Uu RB, SL RB, flexible RB, flexible RB with primary path as Uu, and/or flexible RB with primary path as SL) in a buffer. A WTRU may determine the total data in a buffer. A WTRU may determine the amount of data in a configured set of RBs. For example, a WTRU may determine the amount of data in a set of Uu RBs and/or flexible RBs. A WTRU may determine the amount of data in a set of SL RBs and flexible RBs. A WTRU may determine the amount of data in a set of Uu RBs and flexible RBs with a primary path as Uu. A WTRU may determine the amount of data in a set of SL RBs and flexible RBs with a primary path as SL.

A WTRU may determine one or more parameters of a Uu grant. A WTRU may be scheduled a Uu grant. A Uu grant may include one or any combination of the following parameters: the size of the scheduled grant (e.g., the number of physical resource blocks (PRBs)); the number of repetition resources; the timing of the scheduled grant (e.g., the time gap to the scheduled grant); whether the scheduled grant is within the delay budget of the data in one or more RBs; whether the scheduled grant is within a (pre)configured window (e.g., a (pre)configured time duration); and/or whether the scheduled grant can carry a (pre)configured amount of data.

A WTRU may determine one or more parameters of an SL grant. In examples, a WTRU may select an SL grant (e.g., from multiple SL grants). In some examples, a WTRU may be scheduled an SL grant. An SL grant may include one or any combination of the following parameters for an SL grant: a size of the SL grant (e.g., the number of subchannels for each SL resource of an SL grant); a number of retransmission resources in the SL grant; a timing of the SL grant (e.g., the time gap to the SL grant); whether the SL grant is within the delay budget of the data in one or more RBs; and/or whether the scheduled grant is within a (pre)configured window (e.g., a (pre)configured time duration).

A PDU (e.g., an RLC PDU) retransmission may be performed in one or more examples herein.

A WTRU may retransmit a flexible RB. A WTRU (e.g., remote WTRU) may perform an initial transmission of a PDU (e.g., an RLC PDU). The WTRU may (e.g., then) determine whether to retransmit the PDU, for example, based on one or any combination of the following: an indication from another node (e.g., a relay WTRU, a base station such as a gNB); a periodic retransmission; an RLC response delay; and/or the remaining delay for the PDU.

A WTRU may determine whether to retransmit a PDU (e.g., an RLC PDU) based on an indication from another node (e.g., a relay WTRU, a base station such as a gNB). In some examples, a WTRU may trigger the first retransmission of a PDU (e.g., an RLC PDU) based on an indication from a receiver WTRU. For example, a WTRU may receive an indication (e.g., status report) from one or more receiver WTRUS that an (e.g., one) RLC PDU is missed. The WTRU may (e.g., then) trigger retransmission(s) of the RLC PDU to the one or more receiver WTRUs.

A WTRU may determine whether to retransmit a PDU (e.g., an RLC PDU) based on periodic retransmission(s). For example, a Tx WTRU may (e.g., after the first retransmission is triggered) trigger retransmission of a RLC PDU periodically until the Tx WTRU receives a response from a receiver (e.g., until the Tx WTRU receives the response to a retransmission of the RLC PDU from a receiver WTRU).

A WTRU may determine whether to retransmit a PDU (e.g., an RLC PDU) based on an RLC response delay. For example, the WTRU may trigger retransmission of an RLC PDU if the WTRU has not received the response within a (pre)configured delay window.

A WTRU may determine whether to retransmit a PDU (e.g., an RLC PDU) based on the remaining delay for the PDU. For example, the WTRU may trigger retransmission of an RLC PDU if the remaining delay for the RLC PDU is smaller than a (pre)configured threshold and the WTRU has not received a feedback for the RLC PDU. A threshold (e.g., the threshold for a remaining delay) may be (pre)configured per RB.

A WTRU may determine a PDU retransmission scheme (e.g., an RLC PDU retransmission scheme). For example, a WTRU may determine to retransmit an RLC PDU from a flexible RB. The WTRU may carry out one or any combination of the following retransmission schemes: the WTRU may retransmit the RLC PDU in the same leg as the initial transmission; the WTRU may retransmit the RLC PDU in a different leg compared to the initial transmission; and/or the WTRU may retransmit the RLC PDU in both legs (e.g., in both SL and Uu legs).

A retransmission scheme may be selected based on a retransmission trigger. In examples, a WTRU may select a (e.g., one) retransmission scheme for an (e.g., each) RLC PDU retransmission triggering. The WTRU may indicate the retransmission scheme(s) (e.g., for each retransmission trigger) in one or more retransmitted RLC PDUs. The WTRU may determine which retransmission scheme to use, for example, based on one or any combination of the following: the number of RLC retransmissions the WTRU has made in an SL leg and/or a Uu leg; the remaining delay for the RLC PDU; the leg used for the initial transmission (e.g., whether the leg for the initial transmission is Uu or SL); an indication from another node (e.g., relay WTRU, gNB); a channel condition in a Uu leg (e.g., Uu RSRP); and/or a channel condition in an SL leg (e.g., SL-RSRP and/or Uu RSRP of the relay).

A WTRU may determine which retransmission scheme to use based on the number of RLC retransmissions the WTRU has made in an SL leg and/or a Uu leg. In examples, the WTRU may retransmit the RLC PDU in both legs (e.g., the SL leg and the Uu leg) if the number of transmissions the WTRU has made in one leg is higher than a (pre)configured threshold. In some examples, the WTRU may perform an initial transmission in an SL leg. The WTRU may retransmit the RLC PDU in the same leg as the initial transmission (e.g., the SL leg). The WTRU may (e.g., then) retransmit the RLC PDU in a different leg comparing to the initial transmission (e.g., the Uu leg) if the number of transmissions of the RLC PDU in the SL leg is greater than a (pre)configured threshold. In one or more examples as described herein, the term “SL leg” may be used to refer to an indirect path (e.g., the indirect path as shown in FIG. 6 including an SL MAC 610 and PHY 612, and the term “Uu leg” may be used to refer to a direct path (e.g., the direct path as shown in FIG. 6 including an Uu MAC 606 and PHY 608).

A WTRU may determine which retransmission scheme to use based on the remaining delay for a PDU (e.g., an RLC PDU). For example, the WTRU may retransmit an RLC PDU in both legs (e.g., the SL leg and the Uu leg) if the remaining RLC PDU delay is smaller than a (pre)configured threshold. The WTRU may retransmit the RLC PDU in the same leg (e.g., as the initial transmission) if the remaining RLC PDU delay is equal to or larger than a (pre)configured threshold.

A WTRU may determine which retransmission scheme to use based on the leg used for an initial transmission (e.g., based on whether the leg for the initial transmission is a Uu leg or an SL leg). In examples, the WTRU may retransmit the RLC PDU in the same leg as the initial transmission if the leg used for the initial transmission is a Uu leg. In some examples, the WTRU may retransmit the RLC PDU in both legs (e.g., the SL leg and the Uu leg) if the leg used for the initial transmission is a Uu leg. In some examples, the WTRU may retransmit the RLC PDU in both legs (e.g., the SL leg and the Uu leg) if the leg used for the initial transmission is an SL leg.

A WTRU may determine which retransmission scheme to use based on an indication from another node (e.g., relay WTRU, a base station such as a gNB). For example, the WTRU may be indicated from a base station (e.g., the gNB) which RLC PDU retransmission scheme to use. The WTRU may carry out the indicated retransmission scheme (e.g., by sending a retransmission according to the retransmission scheme) if/when an RLC PDU retransmission is triggered.

A WTRU may determine which retransmission scheme to use based on a channel condition in a Uu leg (e.g., Uu RSRP). In examples, the WTRU may determine an RSRP associated with an Uu leg. The WTRU may retransmit a PDU (e.g., an RLC PDU) in both legs, for example, if the leg for the initial transmission is an Uu leg and if the RSRP associated with the Uu leg is smaller than a (pre)configured threshold. Otherwise (e.g., if the leg for the initial transmission is not a Uu leg or if the RSRP associated with the Uu leg is not smaller than the (pre)configured threshold), the WTRU may retransmit the RLC PDU in the Uu leg (e.g., in the Uu leg only). In some examples, the WTRU may retransmit the RLC PDU in a Uu leg, for example, if the leg for the initial transmission of the RLC PDU is an SL leg and if the RSRP associated with the Uu leg is greater than a (pre)configured threshold. Otherwise (e.g., if the leg for the initial transmission of the RLC PDU is not an SL leg or if the RSRP associated with the Uu leg is not greater than the (pre)configured threshold, the WTRU may retransmit the RLC PDU in both legs (e.g., the SL leg and the Uu leg).

A WTRU (e.g., a remote WTRU) may determine which retransmission scheme to use based on a channel condition in an SL leg (e.g., SL-RSRP and/or Uu RSRP of the relay). In examples, the WTRU may determine an RSRP associated with an SL leg and/or an RSRP associated with a Uu leg of a relay WTRU. The WTRU may retransmit an RLC PDU in both legs (e.g., the SL leg and the Uu leg of the remote WTRU), for example, if the initial transmission of the RLC PDU is a Uu leg of the remote WTRU and if the RSRP associated with the SL leg of the remote WTRU (and/or the RSRP associated with the Uu leg of a relay WTRU) is smaller than a (pre)configured threshold. Otherwise (e.g., if the initial transmission of the RLC PDU is not the Uu leg of the remote WTRU or if the RSRP associated with the SL leg of the remote WTRU) is not smaller than the (pre)configured threshold), the WTRU may retransmit the RLC PDU in the SL leg of the remote WTRU (e.g., only the SL leg of the remote WTRU).

In some examples, a device (e.g., a WTRU, such as a remote WTRU) may determine whether to retransmit a PDU (e.g., an RLC acknowledged mode (AM) protocol data unit (PDU)) in two legs or one leg based on the number of RLC retransmissions made and/or the remaining RLC delay of the RLC PDU. A device may (e.g., be configured to) perform one or more of the following actions. For example, a remote WTRU may be (pre)configured with at least one of the following parameters to trigger RLC AM PDU retransmission in two legs (e.g., a Uu leg and an SL leg): a threshold for the number of RLC PDU retransmissions and/or a threshold for the remaining RLC delay. The device may transmit an RLC PDU. The device may receive a retransmission request for a (e.g., one) RLC PDU (e.g., based on the missing sequence number (SN) reporting from the relay). The device may retransmit the RLC PDU on two legs, for example, if the number of retransmissions of the RLC PDU is greater than the configured threshold or the remaining RLC delay of the RLC PDU is greater than the configured threshold. The device may retransmit the RLC in the same leg as the initial transmission, for example, if otherwise (e.g., if the number of retransmissions of the RLC PDU is not greater than the configured threshold, or the remaining RLC delay of the RLC PDU is not greater than the configured threshold).

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1. A wireless transmit/receive unit (WTRU), comprising:
a processor configured to:
transmit data associated with a protocol data unit (PDU);
receive a retransmission request for the data associated with the PDU;
determine that a first triggering condition of a plurality of triggering conditions is satisfied, wherein the first triggering condition is that the WTRU has retransmitted at least a threshold number of times;
determine, based at least on the satisfaction of the first triggering condition, a retransmission scheme to send the data, wherein the retransmission scheme is a retransmission of the data associated with the PDU using a sidelink (SL) and an uplink (UL), and wherein the retransmission of the data using the SL and the UL comprises sending the data on the SL and sending the data on the UL; and
send the data associated with the PDU using the determined retransmission scheme.

2. The WTRU of claim 1, wherein the PDU is a radio link control (RLC) PDU, wherein the retransmission scheme is determined based on the satisfaction of a second triggering condition of the plurality of triggering conditions, wherein the second triggering condition is that a remaining RLC delay associated with the RLC PDU is equal to or greater than a threshold RLC delay.

3. The WTRU of claim 2, wherein the processor is further configured to receive configuration information that indicates the threshold RLC delay.

4. The WTRU of claim 1, wherein the processor is further configured to receive configuration information that indicates the threshold number of times.

5. The WTRU of claim 1, wherein the processor is further configured to receive a missing sequence number (SN) report, and wherein the missing SN report indicates the retransmission request.

6. A wireless transmit/receive unit (WTRU), comprising:
a processor configured to:
transmit data associated with a protocol data unit (PDU);
receive a retransmission request for the data associated with the PDU;
determine a retransmission scheme based on a triggering condition, wherein the retransmission scheme comprises a retransmission of the data using a sidelink (SL) and an uplink (UL); and
send the data associated with the PDU using the determined retransmission scheme.

7. (canceled)

8. A method performed by a wireless transmit/receive unit (WTRU), comprising:
transmitting data associated with a protocol data unit (PDU);
receiving a retransmission request for the data associated with the PDU;
determining that a first triggering condition of a plurality of triggering conditions is satisfied, wherein the first triggering condition is that the WTRU has retransmitted at least a threshold number of times;
determining, based at least on the satisfaction of the first triggering condition, a retransmission scheme to send the data, wherein the retransmission scheme is a retransmission of the data associated with the PDU using a sidelink (SL) and an uplink (UL), and wherein the retransmission of the data using the SL and the UL comprises sending the data on the SL and sending the data on the UL; and
sending the data associated with the PDU using the determined retransmission scheme.

9. The method of claim 8, wherein the retransmission of the data using the SL and the UL comprises sending the data on the SL and sending the data on the UL.

10. The method of claim 8, wherein the PDU is a radio link control (RLC) PDU, wherein the retransmission scheme is determined based on the satisfaction of a second triggering condition of the plurality of triggering conditions, wherein the second triggering condition is that a remaining RLC delay associated with the RLC PDU is equal to or greater than a threshold RLC delay.

11. The method of claim 10, further comprising receiving configuration information that indicates the threshold RLC delay.

12. The method of claim 8, further comprising receiving configuration information that indicates the threshold number of times.

13. The method of claim 8, further comprising receiving a missing sequence number (SN) report, and wherein the missing SN report indicates the retransmission request.

14. The WTRU of claim 6, wherein the PDU is a radio link control (RLC) PDU, wherein the retransmission scheme is determined based on the satisfaction of a second triggering condition of the plurality of triggering conditions, wherein the second triggering condition is that a remaining RLC delay associated with the RLC PDU is equal to or greater than a threshold RLC delay.

15. The WTRU of claim 14, wherein the processor is further configured to receive configuration information that indicates the threshold RLC delay.

16. The WTRU of claim 6, wherein the processor is further configured to receive configuration information that indicates the threshold number of times.

17. The WTRU of claim 6, wherein the processor is further configured to receive a missing sequence number (SN) report, and wherein the missing SN report indicates the retransmission request.
